(19) United States
(12) Patent Application Publication
(10) Pub. No.: US 2010/0277436 A1
(43) Pub. Date: Nov. 4, 2010

(54) Sensing System for a Touch Sensitive Device

(75) Inventors: Yaojun Feng, Shenzhen (CN); Chen Jung Tsai, Hong Kong (HK); Ying Liu, Hong Kong (HK); Shou-Lung Chen, Hong Kong (HK)

Correspondence Address: Melvin S. Li, 548 Market Street, Suite #33410, San Francisco, CA, 94104, US

(73) Assignee: Hong Kong Applied Science and Technology Research Institute Co., Ltd., Hong Kong (HK)

(21) Appl. No.: 12/431,776

(22) Filed: Apr. 29, 2009

(51) Int. Cl. G06F 3/042

(52) U.S. Cl. 345/175

(57) ABSTRACT

A sensing system for sensing a touch input on a touch sensitive device, the system including: a sensing plane; a well-collimated light source for generating a plurality of light rays along one or more planes different from the sensing plane; and a reflecting means adjacent one edge of the sensing plane for transforming at least a subset of the light rays into substantially parallel light rays and redirecting the subset of light rays along the sensing plane, at least one of the light rays along the sensing plane being interruptable by the touch input thereby allowing the sensing system to determine a position coordinate of the touch input. A related method of sensing a touch input on a touch sensitive device is also provided.

### FIELD OF THE INVENTION

The present invention relates to sensing systems for sensing touch inputs on touch sensitive devices, particularly, but not exclusively, infrared scanning touch panels.

The invention has been developed primarily for use with an infrared scanning touch panel display in order to sense touch inputs from users on said infrared touch panel display. Although the invention will be described with reference to this particular use, it will be appreciated that the invention is not limited to such use.

### BACKGROUND OF THE INVENTION

Prior sensing systems generally include a plurality of transmitters and a plurality of receivers for transmitting and receiving light rays respectively across a touch panel. When a user obstructs one or more of these light rays at a touch location on the touch panel, the corresponding receivers stop receiving the light rays, thereby allowing the position of the touch location to be determined.

One such sensing system includes a plurality of infrared light (IR) transmitters positioned along two adjacent edges of a rectangular planar touch panel. A corresponding plurality of IR receivers are positioned along the other two edges of the rectangular touch panel such that each IR transmitter is opposite a respective IR receiver thereby forming a plurality of transmitter and receiver pairs.

The IR transmitters transmit infrared light rays to respective IR receivers in order to form an IR matrix over the touch panel. When a user touches the touch panel at a touch location, one or more of the light rays are obstructed from reaching the respective IR receiver or receivers. If two intersecting light rays are obstructed, two planar coordinates of the touch location can be determined, thereby determining the position of the touch location on the touch panel.

Sensing systems of this type have many disadvantages. One disadvantage is that the sensing systems require a large number of IR transmitters and IR receivers, especially if greater resolution or accuracy in detecting touches on the touch panel is desired. This results in a large number of components, which increases the manufacturing costs. There is also an increased risk of breakdown, as well as higher maintenance and repair costs.

Another prior IR sensing system includes two IR scanning lasers positioned at diagonally opposite corners of a rectangular touch panel. Each IR scanning laser generates a plurality of divergent infrared light rays that fan out across and over the touch panel, forming an irregular matrix. Retro-reflectors are located along the edges of the touch panel to reflect each light ray back towards the IR scanning laser that generated the light ray for detection by a sensor adjacent the IR scanning laser. When a user touches the touch panel at a touch location, one or more of the light rays are obstructed from reaching the respective sensor, thereby allowing the touch location to be determined.

This prior sensing system also has many disadvantages. The sensing system requires at least two IR scanning lasers, which are relatively expensive components. The irregular matrix formed by the sensing system results in areas of differing resolution and accuracy across the touch panel. In particular, the light rays are closer together nearer to the IR scanning lasers since the light rays generated by the lasers diverge.

Furthermore, when the IR scanning lasers generate light rays aimed directly at each other, the light rays are collinear, forming a so-called “dead line” or “common line”. These “dead lines” or “common lines” are undesirable since only one position coordinate can be determined if the “dead line” or “common line” is obstructed by a user at a touch location on the touch panel. Thus, the position of the touch location is indeterminate since it cannot be determined where along the “dead line” or “common line” the touch location is positioned.

A further prior IR sensing system includes one IR laser positioned beneath and adjacent one corner of a rectangular touch panel. The IR laser fires a light ray through a light guide to a rotating mirror positioned beneath and adjacent another corner of the touch panel opposite the laser. This produces a plurality of divergent light rays that run beneath the touch panel back towards the laser. These divergent light rays strike parabolic mirrors adjacent adjoining edges of the touch panel on either side of the laser and opposite the rotating mirror. The parabolic mirrors transform the light rays into parallel light rays that run back across and beneath the touch panel, forming a light grid under the touch panel. The light rays are then transposed to another plane above the touch panel by vertical light pipes adjacent adjoining edges of the touch panel opposite the parabolic mirrors.

There are also many disadvantages with this prior sensing system. The system requires numerous components, including many mirrors to redirect the light rays into many different directions. This increases the complexity of the system, which requires complicated manufacturing and assembly, resulting in higher manufacturing costs. This in turn increases system maintenance, resulting in higher maintenance costs.

Since the light rays are redirected back and forth across the touch panel many times, the light rays also trace rather long paths. This results in higher light loss and larger laser spot sizes, which reduces sensing resolution and accuracy. Also, the sensing system utilizes parabolic mirrors, which have large footprints, thereby increasing the size of the system and compromising compactness.

It is an object of the present invention to overcome or ameliorate at least one of the disadvantages of the prior art, or to provide a useful alternative.

### SUMMARY OF THE INVENTION

The present invention provides in a first aspect a sensing system for sensing a touch input on a touch sensitive device, the system including a sensing plane, and a well-collimated light source for generating a plurality of light rays along one or more planes different from the sensing plane. The sensing system further includes a reflecting means adjacent one edge of the sensing plane for transforming at least a subset of the light rays into substantially parallel light rays and redirecting the subset of light rays along the sensing plane, at least one of the light rays along the sensing plane being interruptable by the touch input thereby allowing the sensing system to determine a position coordinate of the touch input.

In a second aspect, the present invention provides a method of sensing a touch input on a touch sensitive device, the method including generating a plurality of well-collimated light rays along one or more planes different from a sensing plane. The method further including, adjacent one edge of the sensing plane, transforming at least a subset of the light rays into substantially parallel light rays and redirecting the subset of light rays along the sensing plane, at least one of the light rays along the sensing plane being interruptable by the touch input thereby allowing a position coordinate of the touch input to be determined.

Preferred features of the present invention are disclosed in the appended dependent claims and form part of the present summary of the invention.

### BRIEF DESCRIPTION OF THE FIGURES

Preferred embodiments in accordance with the best mode of the present invention will now be described, by way of example only, with reference to the accompanying figures, in which:

FIG. 1 is a schematic perspective view of a sensing system in accordance with a preferred embodiment of the present invention;

FIG. 2 is a schematic perspective view of a first variation of the sensing system of FIG. 1;

FIG. 3(a) is a schematic partial perspective view of the first variation of the sensing system of FIG. 1;

FIG. 3(b) is a schematic partial perspective view of a second variation of the sensing system of FIG. 1;

FIG. 4 is a schematic plan view of the sensing system of FIG. 1, showing in solid lines the paths of light rays underneath the touch panel, and in dotted lines the paths of said light rays along the sensing planes above the touch panel;

FIG. 5 is a schematic plan view of the first variation of the sensing system of FIG. 1, showing in solid lines the paths of two light rays wherein the return paths are parallel to the respective outward paths;

FIG. 6 is a schematic plan view of the second variation of the sensing system of FIG. 1, showing in solid lines the paths of two light rays wherein the return paths are parallel to the respective outward paths;

FIG. 7 is a schematic plan view of the sensing system of FIG. 1, showing in dotted lines the paths of light rays along the sensing planes above the touch panel, and an object just before touching the touch panel and interrupting two of said light rays;

FIG. 8 is a schematic plan view of the sensing system of FIG. 1, showing in solid lines the paths of two light rays, and an object touching the touch panel and interrupting said two light rays;

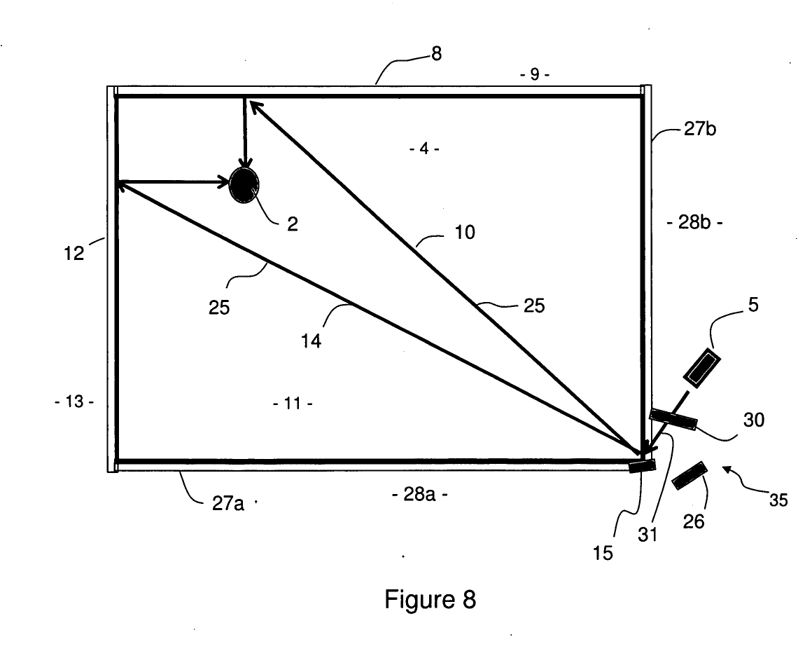

FIG. 9 is a schematic side view of the sensing system of FIG. 1, showing in solid lines the path of one light ray wherein the return path is parallel to the outward path;

FIG. 10 is a schematic side view of the sensing system of FIG. 1, showing in solid lines the path of one light ray, and an object touching the touch panel and interrupting said light ray;

FIG. 11 is a schematic side view of a third variation of the sensing system of FIG. 1, showing in solid lines the path of one light ray wherein the return path is parallel to the outward path;

FIG. 12 is a schematic side view of the third variation of the sensing system of FIG. 1, showing in solid lines the path of one light ray, and a touch on the touch panel interrupting said light ray;

FIG. 13(a) is a schematic diagram of the scanning and sensing module of the second variation of the sensing system of FIG. 1, showing in solid lines the partial path of one light ray wherein said light ray passes through the hole in the sensor on the outward path, but strikes said sensor on the return path, which is parallel and offset to the outward path;

FIG. 13(b) is a schematic diagram of the scanning and sensing module of the second variation of the sensing system of FIG. 1, showing in solid lines the partial path of one light ray wherein said light ray passes through the hole in the sensor on the outward path, but strikes said sensor on the return path, which is substantially parallel and offset to, but deviates slightly from, the outward path;

FIG. 14 is a schematic plan view of the rotating reflector of the sensing system of FIG. 1, shown in the form of a rotating polygonal reflector, and showing in solid line one light ray being reflected off the reflector; and

FIG. 15 is a schematic diagram of a portion of the retro-reflector used in variations of the sensing system of FIG. 1 in order to make the return paths of light rays parallel to, or substantially parallel to, but deviating slightly from, the respective outward paths of said light rays.

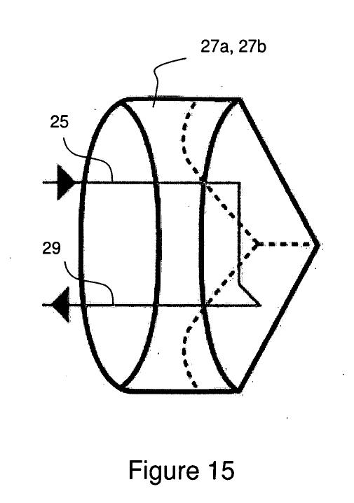

### DETAILED DESCRIPTION OF THE BEST MODE OF THE INVENTION

Referring to the figures, a sensing system 1 for sensing a touch input 2 on a touch sensitive device 3 is provided. The sensing system 1 includes a sensing plane 4 and a well-collimated light source 5 for generating a plurality of light rays 6 along one or more planes 7 different from the sensing plane 4. A reflecting means 8 is adjacent one edge 9 of the sensing plane for transforming at least a subset 10 of the light rays 6 into substantially parallel light rays and redirecting the subset of light rays along the sensing plane 4. At least one of the light rays 10 along the sensing plane 4 is interruptable by the touch input 2 thereby allowing the sensing system 1 to determine a position coordinate of the touch input.

Also included is a second said sensing plane 11 that is also different to the one or more planes 7 along which the plurality of light rays 6 are generated. A second said reflecting means 12 is adjacent one edge 13 of the second sensing plane 11 for transforming a second subset 14 of the light rays 6 into substantially parallel light rays and redirecting the second subset of light rays 14 along the second sensing plane 11 in a direction different to the direction of the first subset of light rays 10. The first and second subsets of light rays 10 and 14 thereby form a light grid, and at least one of the light rays from the second subset 14 along the second sensing plane 11 is interruptable by the touch input 2 thereby allowing the sensing system 1 to determine a second position coordinate of the touch input.

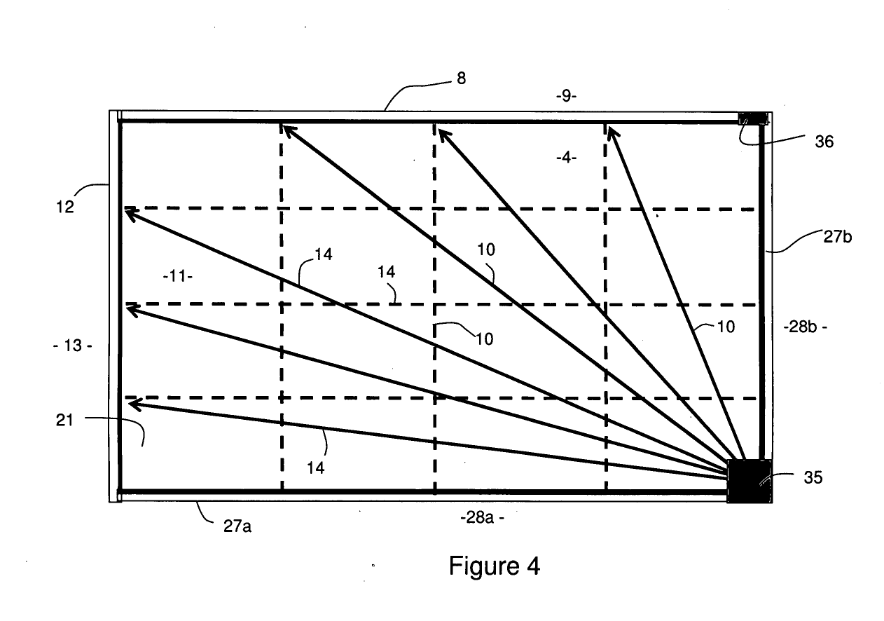

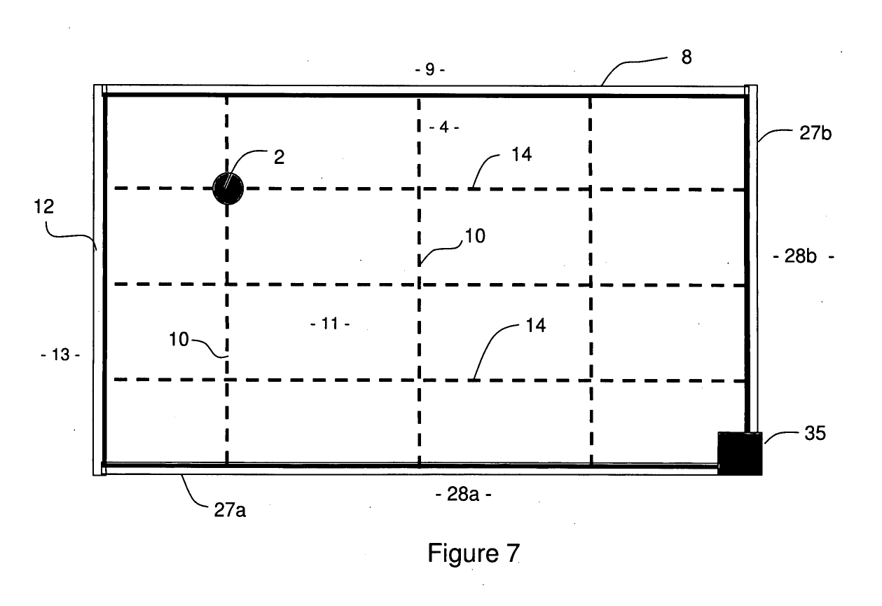

The first and second subsets of light rays 10 and 14 are substantially orthogonal to each other and substantially uniformly spaced apart, the light grid thereby being a substantially uniform orthogonal light grid, as best shown in FIGS. 4, 5, 6 and 7. The first and second sensing planes 4 and 11 are also substantially coplanar, and therefore, the first and second subsets of light rays 10 and 14 are substantially coplanar. In particular, the coplanar sensing planes 4 and 11 define a common rectangular plane, and the edges 9 and 13, to which the first and second reflecting means 8 and 12 are respectively adjacent, are two adjoining edges of the common rectangular plane.

In other embodiments, however, the first and second sensing planes 4 and 11 are not coplanar. In some embodiments, the first and second sensing planes 4 and 11 are parallel and offset from each other so that the velocity of the touch input 2 can be determined in addition to position coordinates. More particularly, the velocity can be calculated by dividing the distance between the parallel first and second sensing planes 4 and 11 by the amount of time between when a light ray from the first subset of light rays 10 is interrupted by the touch input 2 and when a light ray from the second subset of light rays 14 is interrupted by the touch input 2. Also, it will be appreciated that the sensing planes 4 and 11 can be many different shapes and sizes in addition to rectangular.

The well-collimated light source 5 includes a single laser that generates infrared light. The sensing system 1 further includes a rotating reflector 15, and the well-collimated light source 5 generates at least one light ray that strikes the rotating reflector 15 thereby generating the plurality of light rays 6 in the form of divergent light rays, as shown in FIGS. 4, 5 and 6. In the present embodiment, the plurality of divergent light rays 6 are substantially coplanar. The light source 5 can fire a single continuous light ray or multiple light rays at the rotating reflector 15.

In the case of multiple light rays, the multiple light rays trace the same path to the rotating reflector 15 but diverge from the rotating reflector to generate the plurality of divergent light rays 6. The multiple light rays can be time sequenced so that the plurality of light rays 6 are generated at regular time intervals.

In the case of a single continuous light ray, the rotating reflector 15 can be rotated so that the single continuous light ray generates the plurality of light rays 6 diverging from the rotating reflector 15 at regular time intervals. It will be appreciated that each one of the plurality of light rays 6 can be seen as starting from the light source 5, that is, the light rays share a common portion between the light source 5 and the rotating reflector 15.

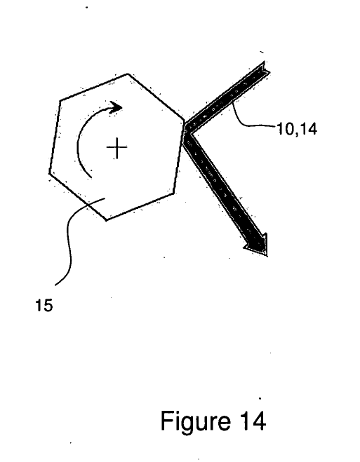

In other embodiments, the light source 5 itself can be rotated to generate the plurality of light rays 6. In yet other embodiments, the plurality of light rays 6 can be generated using multiple light sources 5. Also, although the present embodiment uses a infrared laser, other types of well-collimated light sources can be used. For example, other embodiments use single or multiple LEDs, or multiple lasers. As well as infrared, other wavelengths of light can be used. Also, instead of being divergent, the light rays generated by the light sources of other embodiments can emanate from the light sources in many other patterns such as parallel or randomly oriented rays. The rotating reflector 15 can include a rotating polygonal mirror, a MEMS scanning mirror or a vibrating reflector. FIG. 14 shows such a rotating polygonal mirror.

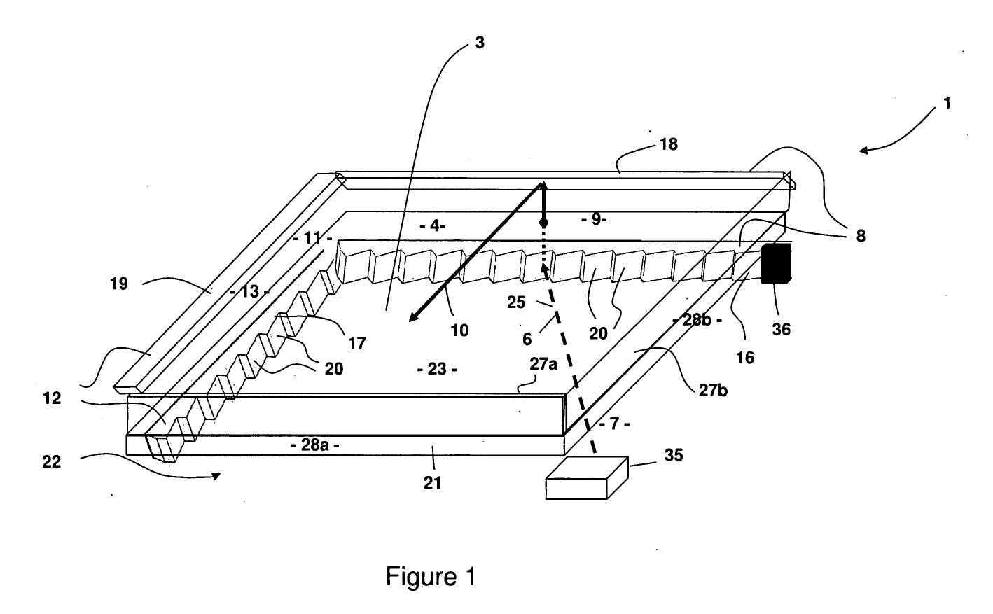

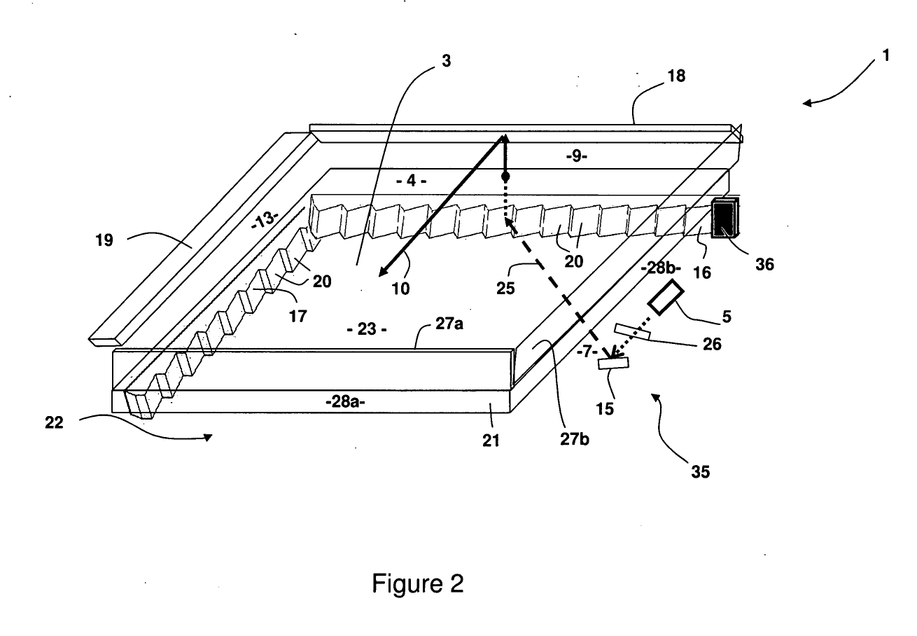

The first and second reflecting means 8 and 12 each include a first reflector 16 and 17 respectively and a second reflector 18 and 19 respectively, as best shown in FIGS. 1, 2, 3(a), 3(b), 9, 10, 11 and 12. Each first reflector 16 and 17 redirects the respective subset of light rays 10 and 14 from the light source 5 to the respective sensing plane 4 and 11, and each second reflector 18 and 19 redirects the respective subset of light rays 10 and 14 from the respective first reflector 16 and 17 such that the respective subset of light rays 10 and 14 runs along the respective sensing plane 4 and 11.

In other words, the first reflector 16 of the first reflecting means 8 redirects the first subset of light rays 10 from the light source 5 to the first sensing plane 4, and the second reflector 18 of the first reflecting means 8 redirects the first subset of light rays 10 from the first reflector 16 such that the first subset of light rays 10 runs along the first sensing plane 4. Similarly, the first reflector 17 of the second reflecting means 12 redirects the second subset of light rays 14 from the light source 5 to the second sensing plane 11, and the second reflector 19 of the second reflecting means 12 redirects the second subset of light rays 14 from the first reflector 17 such that the second subset of light rays 14 runs along the second sensing plane 11.

Since the first reflecting means 8 is adjacent one edge 9 of the first sensing plane 4, both the first and second reflectors 16 and 18 of the first reflecting means are also adjacent the one edge 9. Similarly, since the second reflecting means 12 is adjacent one edge 13 of the second sensing plane 11, both the first and second reflectors 17 and 19 of the second reflecting means are also adjacent the one edge 13.

For ease of description, for here onwards, references to a feature of multiple number shall be read as references to each instance of the feature unless otherwise indicated. In particular, references to the subset of light rays shall be read as references to each of the first and second subsets of light rays 10 and 14, references to the sensing plane shall be read as references to each of the first and second sensing planes 4 and 11, references to the reflecting means shall be read as references to each of the first and second reflecting means 8 and 12, references to the first reflector shall be read as references to each of the first reflector 16 of the first reflecting means 8 and the first reflector 17 of the second reflecting means 12, and references to the second reflector shall be read as references to each of the second reflector 18 of the first reflecting means 8 and the second reflector 19 of the second reflecting means 12.

Following on from the above, it will be appreciated that when a first feature of multiple number is described with reference to a second feature of multiple number, this shall be read as describing each instance of the first feature with reference to only the corresponding instance of the second feature. For example, “the subset of light rays 10 and 14 run along the sensing plane 4 and 11” shall be read as “the first subset of light rays 10 run along the first sensing plane 4” and separately “the second subset of light rays 14 run along the second sensing plane 11”.

Either the first reflector 16 and 17 or the second reflector 18 and 19 transforms the subset of light rays 10 and 14 into substantially parallel light rays. In the present embodiment, the first reflector 16 and 17 transforms the subset of light rays 10 and 14 into substantially parallel light rays and the second reflector 18 and 19 is a planar reflector to redirect the parallel light rays along the sensing plane 4 and 11. Thus, the first reflector 16 and 17 both redirects the subset of light rays 10 and 14 from the light source 5 to the sensing plane 4 and 11, and transforms the subset of light rays 10 and 14 into substantially parallel light rays.

In other embodiments, the second reflector 18 and 19 transforms the subset of light rays 10 and 14 into substantially parallel light rays, and therefore, does this in addition to redirecting the subset of light rays 10 and 14 from the first reflector 16 and 17 such that the subset of light rays runs along the sensing plane 4 and 11. Thus, the functionalities of the first reflector 16 and 17 and the second reflector 18 and 19 can be reversed.

Returning to the present embodiment, the first reflector 16 and 17 includes a plurality of reflecting facets 20 each tilted with respect to a plane orthogonal to a respective light ray of the subset of light rays 10 and 14 to redirect the respective light ray to the sensing plane in a direction substantially parallel to the other light rays of the subset. In particular, each reflecting facet 20 is tilted about two axes that form three orthogonal axes together with the respective light ray. More particularly, the reflecting facets 20 are tilted such that the subset of light rays 10 and 14, which are substantially coplanar before they reach the reflecting facets 20, are redirected orthogonally towards the sensing plane 4 and 11. The second reflector 18 and 19, which is a planar reflector, then redirects the subset of light rays 10 and 14 orthogonally along the sensing plane 4 and 11.

In one embodiment, the first reflector 16 and 17 is a mirror array with each mirror forming one of the reflecting facets 20. In other embodiments, the first reflector 16 and 17 is a stepped mirror integrating the plurality of facets 20. As such the first reflector 16 and 17 can be integrally molded. For example, the first reflector can be made of integrally molded plastics material in a stepped profile with a reflective coating applied to the faces of the stepped profile, thereby forming the plurality of reflecting facets 20.

In the present embodiment, the first reflectors 16 and 17 of the first and second reflecting means 8 and 12 respectively are adjacent and run along adjoining edges 9 and 13 of the common rectangular plane defined by the first and second sensing planes 4 and 11. Similarly, the second reflectors 18 and 19 of the first and second reflecting means 8 and 12 respectively are adjacent and run along adjoining edges 9 and 13 of the common rectangular plane, albeit spaced apart from the corresponding first reflectors 16 and 17.

The first reflectors 16 and 17 can be integrally molded as one unit. The second reflectors 18 and 19 can also be integrally molded as one unit. The first reflector 16 and second reflector 18 of the first reflecting means 8 can be integrally molded as one unit. The first reflector 17 and second reflector 19 of the second reflecting means 12 can also be integrally molded as one unit. Furthermore, the first reflectors 16 and 17 and the second reflectors 18 and 19 can all be integrally molded as one unit.

This advantageously simplifies assembly of the first and second reflecting means 8 and 12, since the first reflectors 16 and 17 and the second reflectors 18 and 19, or combinations thereof, do not have to be installed separately. This can also minimise the requirement to separately align the first reflectors 16 and 17 and second reflectors 18 and 19, or combinations thereof, during assembly since they are pre-aligned when integrally molded.

The first and second reflectors 16, 17, 18 and 19 can be made of metal, glass, plastics, composites, any combination thereof, or any other appropriate material, that has a reflective surface, a reflective coating, or otherwise adapted to reflect light.

In the present embodiment, the touch sensitive device 3 includes a touch panel 21, and the subset of light rays 10 and 14 is on a first side 22 of the touch panel before reaching the reflecting means 8 and 12.

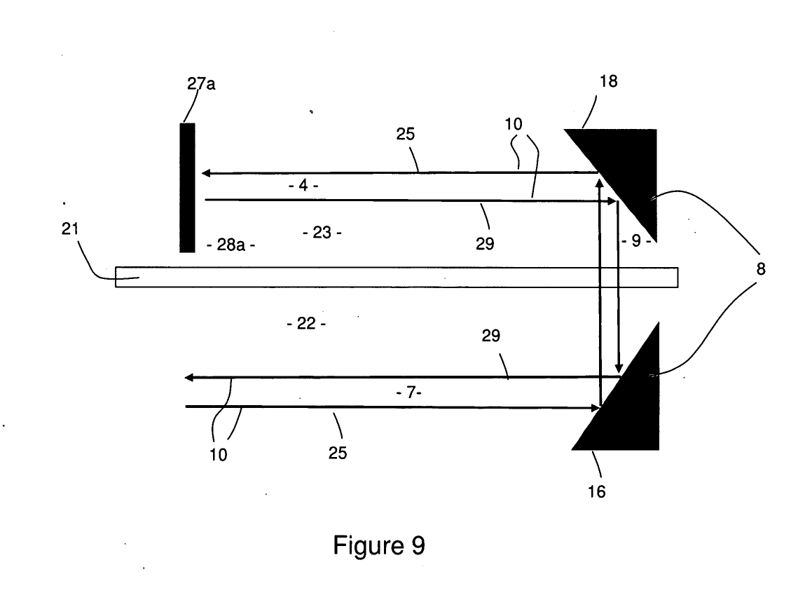

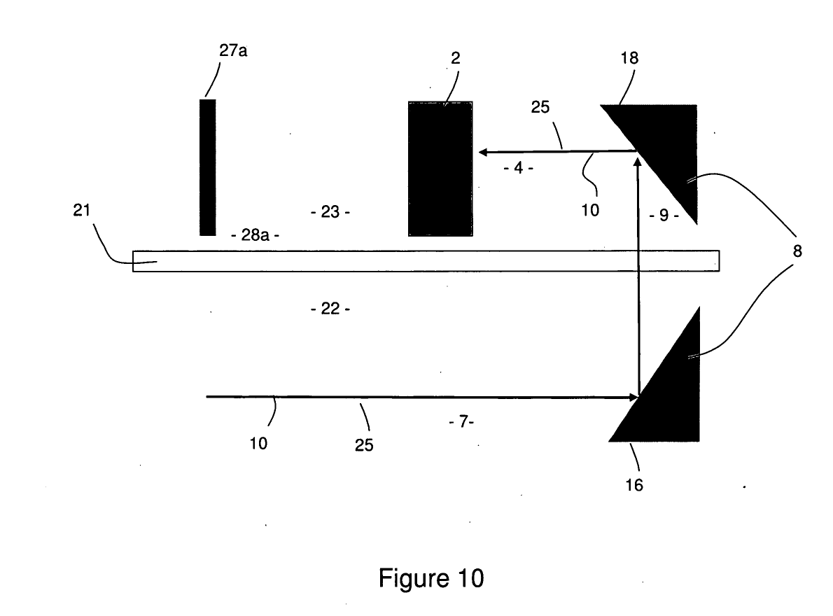

In one variation, as best shown in FIGS. 9 and 10, the sensing plane 4 and 11 is on a second side 23 of the touch panel 21, the second side opposite the first side 22, such that at least one of the light rays 10 and 14 along the sensing plane 4 and 11 is interruptable by the touch input 2 being placed on or adjacent the touch panel 21 thereby allowing the sensing system 1 to determine a position coordinate of the touch input on the touch panel. More particularly, the light rays along the sensing plane 4 and 11 are interruptable by the touch input 2 obstructing the light rays along the sensing plane 4 and 11 at the location of the touch input 2.

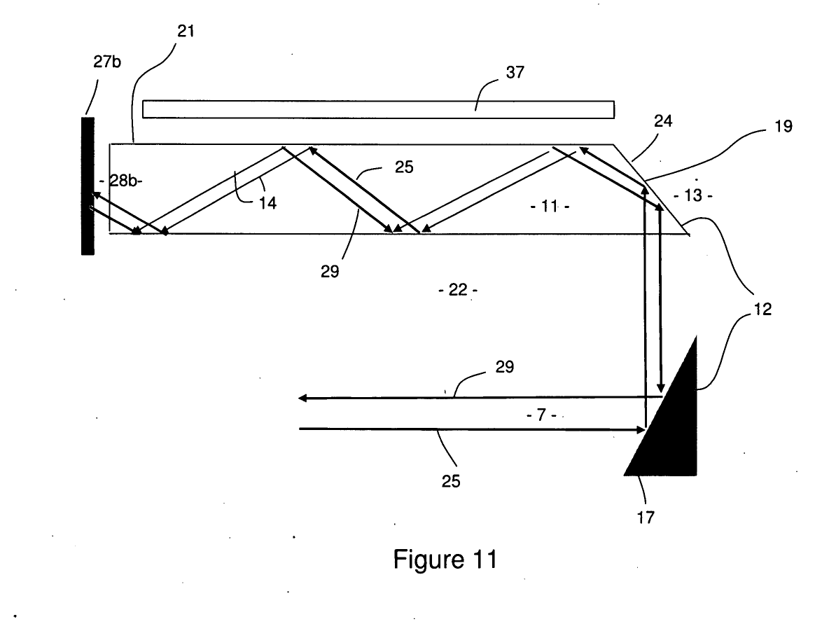

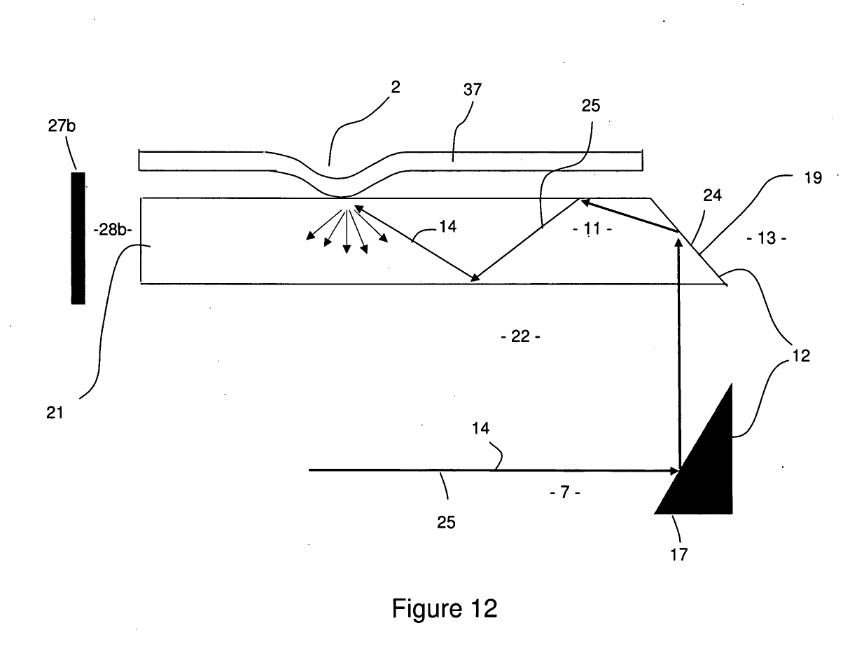

In a second variation, as best shown in FIGS. 11 and 12, the sensing plane 4 and 11 passes through the touch panel 21 such that at least one of the light rays 10 and 14 along the sensing plane 4 and 11 is interruptable by the touch input 2 being placed on or adjacent the touch panel 21 thereby allowing the sensing system 1 to determine a position coordinate of the touch input on the touch panel. More particularly, the light rays along the sensing plane 4 and 11 are interruptable by one or more of reflection, refraction, and diffraction caused by the touch input 2 being placed on or adjacent the touch panel 21. This results in the destruction of total internal reflection of the light rays along the sensing plane 4 and 11 at the location of the touch input 2.

A flexible contact layer 37 is included over the touch panel 21. The flexible layer 37 protects the touch panel 21, and provides a softer and more tactile feel. The layer 37 also ensures that the subset of light rays 10 and 14 at the touch input are only interrupted when a deliberate touch is pressed onto the touch panel 21 and not when a light object, such as dust, falls onto the touch panel.

In an embodiment of the second variation, the touch panel 21 includes at least one reflective edge 24 that forms at least part of the reflecting means 8 and 12, the reflective edge 24 redirecting the subset of light rays 10 and 14 along the sensing plane 4 and 11 through the touch panel 21.

In the present embodiment, the subsets of light rays 10 and 14 form an orthogonal light grid along the sensing plane 4 and 11. Therefore, if there is an interruption of at least two light rays of the light rays along the sensing plane 4 and 11, one from each of the subsets of light rays 10 and 14 and the at least two light rays intersecting, then the sensing system 1 can determine two position coordinates of the touch input 2 on the touch panel 21, thereby locating the touch input 2 on the touch panel 1.

The touch panel 21 of the present embodiment is a transparent acrylic display screen for displaying visual information. The subset of light rays 10 and 14 going between the first reflector 16 and 17 and the second reflector 18 and 19 can either pass by an edge of the touch panel or pass through the transparent touch panel 21. In other embodiments, the touch panel 21 has a transparent portion in the form of a peripheral strip or strips along one or more edges of the touch panel to allow the subset of light rays 10 and 14 to go through the touch panel 21. The transparent portion can be made of materials such as glass or perspex.

For the present purpose of description, the touch panel 21 is oriented horizontally. However, it will be appreciated that the touch panel 21 can be oriented in many other orientations. Thus, the first side 22 is the area underneath the touch panel 21, whereas the second side 23 is the area above the touch panel 21. The touch panel 21 can also be made of other materials or combinations of materials.

Each light ray of the subset of light rays 10 and 14 traces a respective outward path 25 from the light source 5 to the reflecting means 8 and 12 and along the sensing plane 4 and 11. The sensing system 1 further includes a sensing means 26 and a return reflector 27a and 27b, as best shown in FIGS. 1, 2, 9, 10, 11 and 12. The return reflector 27a and 27b is adjacent a second edge 28a and 28b of the sensing plane 4 and 11, the second edge 28a and 28b opposite the first edge 9 and 13, for redirecting each light ray of the subset of light rays 10 and 14 back along a respective return path 29 that is substantially parallel to the respective outward path 25 to the sensing means 26. It will be appreciated that in the present embodiment, there are two return reflectors 27a and 27b, each adjacent a respective second edge 28a and 28b that is opposite a corresponding one of the first edges 9 and 13.

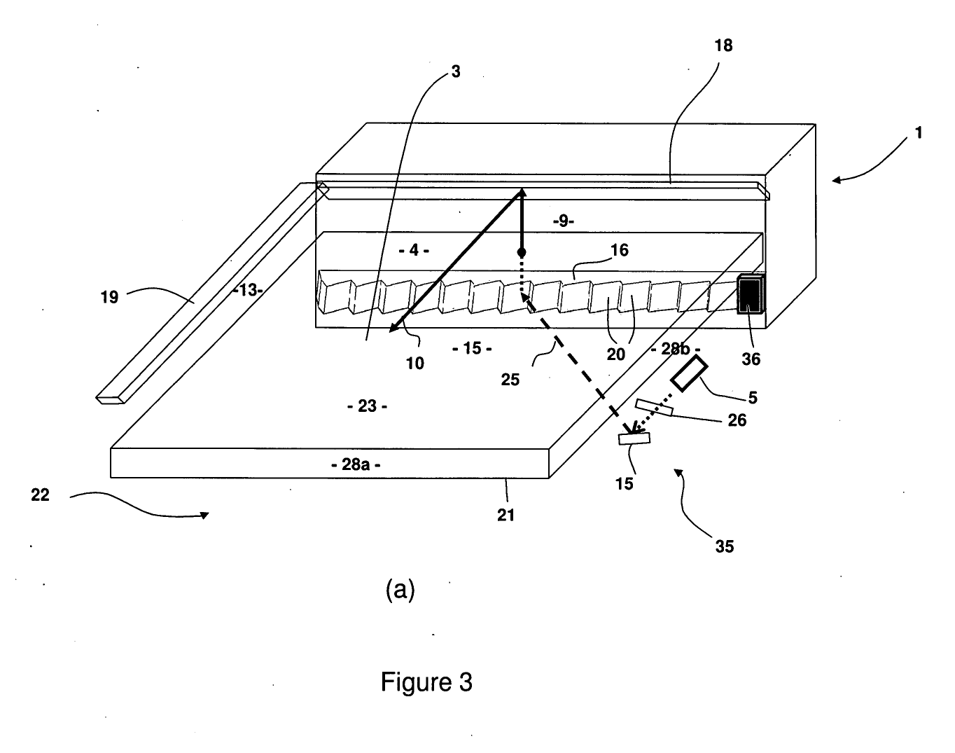

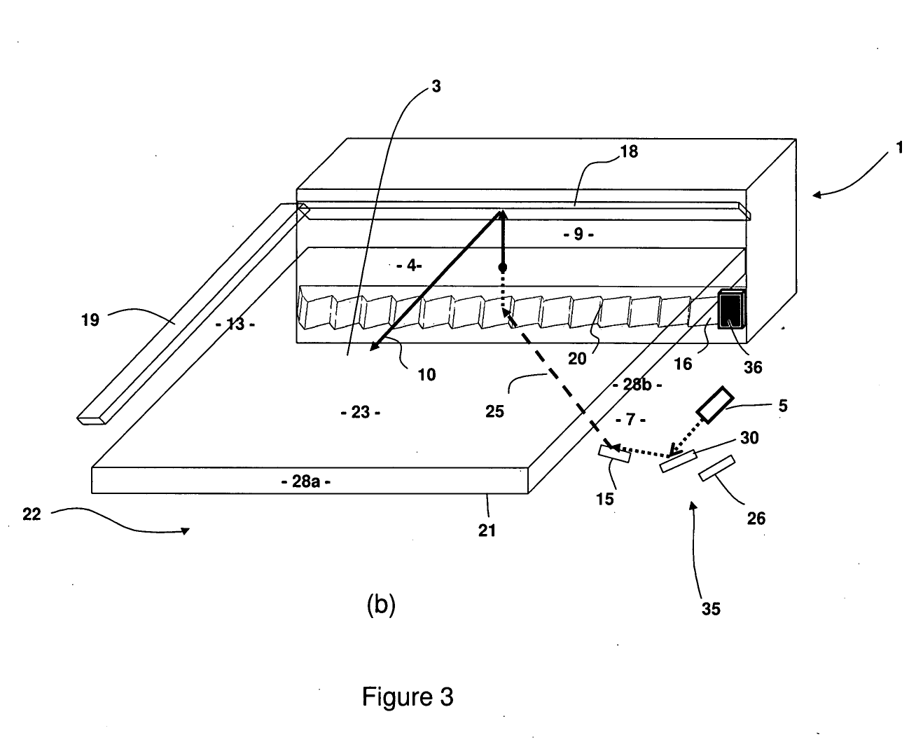

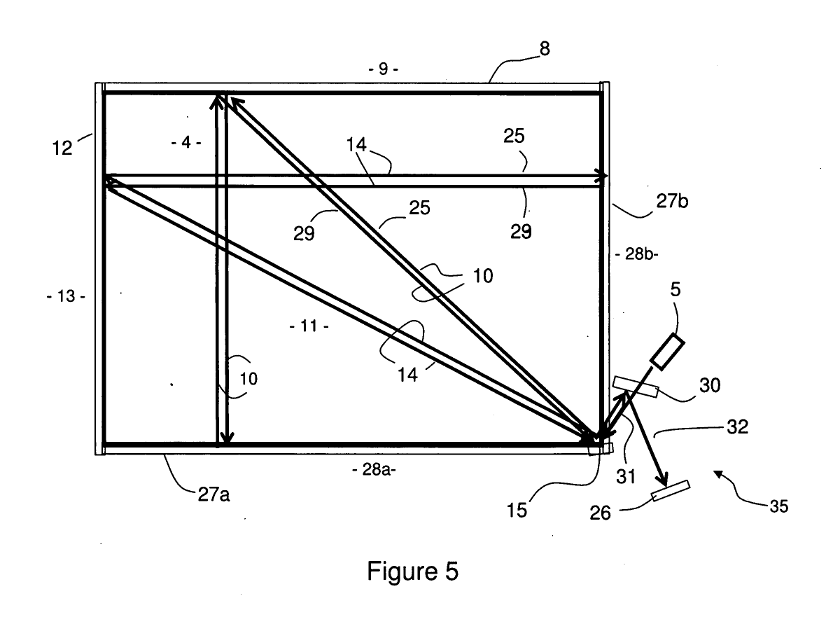

In one variation, as best shown in FIGS. 3(b) and 5, the sensing system includes a beam splitter 30 positioned between the rotating reflector 15 and the light source 5. The beam splitter 30 reflects some portion of incident light, while transmitting another portion of incident light. Thus, an outward portion 31 of each light ray passes through the beam splitter 30 to continue along the respective outward path 25. The outward portion 31 then returns along the respective return path 29 whereby a return portion 32 of the outward portion 31 is redirected by the beam splitter 30 to the sensing means 26.

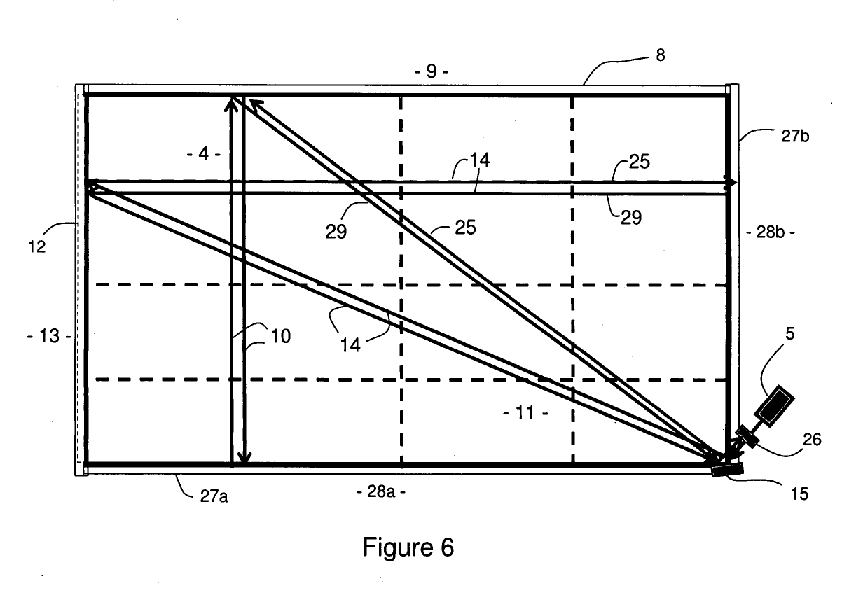

In another variation, as best shown in FIGS. 3(a) and 6, the return reflector 27a and 27b is a retro reflector such that the respective return path 29 is offset from the respective outward path 25. The sensing means 26 includes a sensing surface 33 and a hole 34 passing through the sensing surface. The sensing means 26 is positioned between the rotating reflector 15 and the light source 5 such that each light ray passes through the hole 34 on the respective outward path 25 and strikes the sensing surface 33 on the respective return path 29.

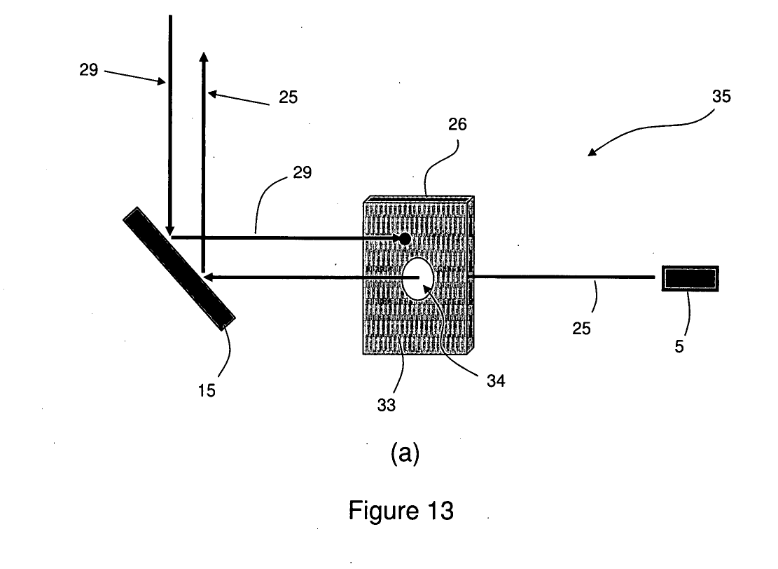

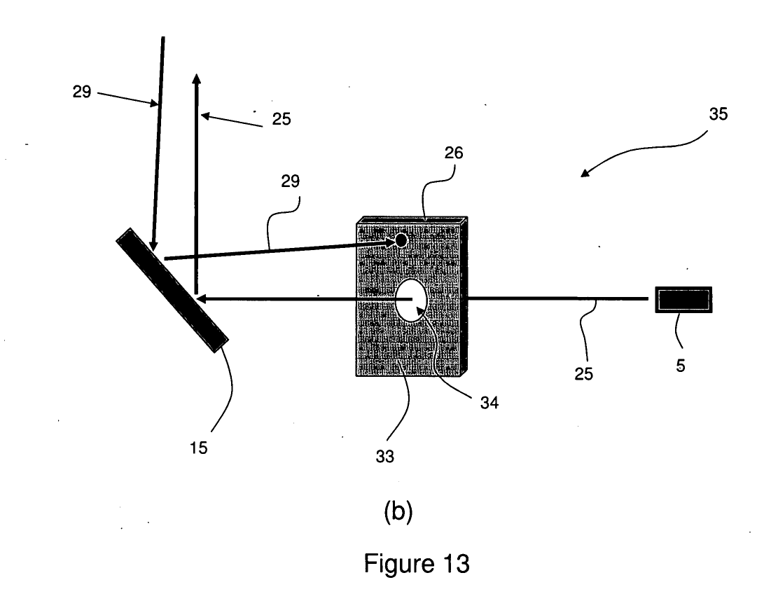

It will be appreciated that the respective return path 29 does not have to be exactly parallel to the respective outward path 25, but can deviate slightly at a small angle to the respective outward path 25, as best shown in FIG. 13(b). This applies in both cases where the respective return path 29 is substantially coincident with the respective outward path 25 and where the respective return path 29 is substantially offset to the respective outward path 25.

Like the first and second reflectors 16, 17, 18 and 19, the return reflectors 27a and 27b can be integrally molded as one unit, and can be made of metal, glass, plastics, composites, any combination thereof, or any other appropriate material, that has a reflective surface, a reflective coating, or otherwise adapted to reflect light. In the present embodiment, the sensing means 26 includes an optical sensor, which preferably includes a semiconductor photodiode.

Having one or more of the return reflectors 27a and 27b has the significant advantage that a corresponding sensing means 26 can be positioned closely adjacent each well-collimated light source 5. In embodiments where there is a single light source 5, such as in the present embodiment, there is the particular advantage that the sensing means 26 can be a single sensing means 26 positioned closely adjacent the single light source 5, the single sensing means for sensing the subsets of light rays 10 and 14 reflected back along the respective return paths 29. Advantageously, the light source 5, rotating reflector 15, the sensing means 26, and depending on which variation, the beam splitter 30, can all form part of a single integrated scanning and sensing module 35.

One or more calibration sensors 36 are also provided, each positioned at a respective predetermined location. A respective one of the plurality of light rays 6 strikes a corresponding one of the calibration sensors 36 whereby the time sequence of the plurality of light rays can be determined, thereby allowing each light ray to be identified. In the present embodiment, one calibration sensor 36 is located at one end of one of the first reflectors 16 and 17. The sensing system records the time at which one of the plurality of light rays 6 strikes the calibration sensor 36. This marks the beginning of one scanning cycle. Accordingly, the length of one scanning cycle, that is, the scanning period, can be calculated as the time interval between sequential strikes on the calibration sensor 36.

In embodiments using a rotating polygonal mirror, the rotational speed is generally constant. Therefore, the time when a particular light ray of the plurality of light rays 6 is fired can be calculated by a simple linear function of the scanning period. In embodiments using an oscillating or vibrating mirror, such as a MEMS mirror, the speed is a sinusoidal function of time. Therefore, the time when a particular light ray of the plurality of light rays 6 is fired can be calculated by an inverse trigonometric function of the scanning period. Thus, when a particular position coordinate is being scanned is also known since this corresponds to the particular light ray. This allows the sensing system 1 to identify which light rays along the sensing planes 4 and 11 have been interrupted by the touch input 2, which in turn, allows the sensing system 1 to identify the position coordinates of the touch input.

It will be appreciated that there are other embodiments that have only one of the reflecting means 8 and 12. In these embodiments, only one position coordinate of the touch input 2 can be determined, since there is only one of the subsets of light rays 10 and 14 running along the respective sensing plane 4 and 11 in one direction. However, it will be appreciated that light rays in other directions across the input panel can be generated and sensed using other means. For example, a plurality of well-collimated light sources can be provided adjacent another edge of the respective sensing plane 4 and 11 to generate light rays in a second direction. A plurality of sensors can also be provided along an opposite edge for sensing these light rays in the second direction, thereby allowing two position coordinates, and therefore the location, of the touch input 2 to be thereby determined.

There are also embodiments that have more than two reflecting means. In some of these embodiments, having more than two reflecting means increases the precision or accuracy of the sensing system 1 since more light rays in more directions are generated. In other embodiments, having more than two reflecting means allows the sensing system 1 to determine more than two position coordinates of the touch input 2. For example, if three position coordinates can be determined, a three dimensional location of the touch input can be calculated. In these embodiments, the multiple sensing planes that correspond to the multiple reflecting means can be coplanar or stacked, or a mixture thereof.

The sensing system 1 of the present invention allows the subsets of light rays 10 and 14 running along the sensing planes 4 and 11 to be closely spaced apart, thereby providing an improved resolution in sensing touch inputs 2. Spacings of about 1 mm are achievable between the parallel light rays 10 and 14 running along the sensing planes 4 and 11.

The present invention in another aspect also provides a method of sensing a touch input on a touch sensitive device. A preferred embodiment of this aspect of the invention is a method that includes some of the features of the sensing system 1 described above.

Accordingly, the preferred embodiment of the method includes generating the plurality of well-collimated light rays 6 along the one or more planes 7 different from the sensing plane 4; and adjacent the one edge 9 of the sensing plane 4, transforming at least the subset 10 of the light rays 6 into substantially parallel light rays and redirecting the subset of light rays along the sensing plane 4. At least one of the light rays 10 along the sensing plane 4 is interruptable by the touch input 2 thereby allowing a position coordinate of the touch input to be determined.

As described above, the one or more planes 7 along which the plurality of light rays 6 is generated are also different to the second sensing plane 11. The present embodiment also includes, adjacent the one edge 13 of the second sensing plane 11, transforming the second subset 14 of the light rays 6 into substantially parallel light rays and redirecting the second subset 14 of light rays along the second sensing plane 11 in a direction different to the direction of the first subset 10 of light rays. The first and second subsets of light rays thereby form a light grid. At least one of the light rays from the second subset 14 along the second sensing plane 11 is interruptable by the touch input 2 thereby allowing a second position coordinate of the touch input to be determined. The light rays of the first and second subsets 10 and 14 are generated such that they are substantially orthogonal to each other and substantially uniformly spaced apart, the light grid thereby being a substantially uniform orthogonal light grid.

The present embodiment further includes a first step of redirecting the subset of light rays 10 and 14 to the sensing plane 4 and 11, and then a second step of redirecting the subset of light rays along the sensing plane. Either the first step or the second step includes transforming the subset of light rays 10 and 14 into substantially parallel light rays. In the present embodiment, the first step includes transforming the subset of light rays 10 and 14 into substantially parallel light rays.

The present embodiment includes using the respective reflecting facet 20 of the first reflector 16 and 17 to redirect each light ray of the subset of light rays 10 and 14 to the sensing plane 4 and 11 in a direction substantially parallel to the other light rays of the subset. As described above, each reflecting facet 20 is tilted with respect to a plane orthogonal to the corresponding light ray.

As above, the touch sensitive device 3 includes the touch panel 21, and the subset of light rays 10 and 14 is on the first side 22 of the touch panel before being redirected to the sensing plane 4 and 11.

In one variation, the sensing plane 4 and 11 is on the second side 23 of the touch panel 21, the second side opposite the first side 22, such that at least one of the light rays 10 and 14 along the sensing plane 4 and 11 is interruptable by the touch input 2 being placed on or adjacent the touch panel 21 thereby allowing a position coordinate of the touch input on the touch panel to be determined.

In a second variation, the sensing plane 4 and 11 passes through the touch panel 21 such that at least one of the light rays 10 and 14 along the sensing plane 4 and 11 is interruptable by the touch input 2 being placed on or adjacent the touch panel 21 thereby allowing a position coordinate of the touch input on the touch panel to be determined.

As above, the touch panel 21 includes the at least one reflective edge 24. The present embodiment further includes using the reflective edge 24 of the touch panel 21 to redirect the subset of light rays 10 and 14 along the sensing plane 4 and 11 through the touch panel 21.

The plurality of light rays is generated in the form of divergent light rays by firing at least one light ray from the well-collimated light source 5 at the rotating reflector 15.

As above, each light ray of the subset of light rays 10 and 14 traces the respective outward path 25 from the light source 5 to the sensing plane 4 and 11 and along the sensing plane. The present embodiment of the method further includes, adjacent the second edge 28a and 28b of the sensing plane 4 and 11, which is opposite the first edge 9 and 13, redirecting each light ray of the subset of light rays 10 and 14 back to the light source 5 along the respective return path 29 that is substantially parallel to the respective outward path 25. The embodiment also includes sensing each light ray of the subset of light rays 10 and 14 on the respective return path 29.

In one variation, the present embodiment includes using the beam splitter 30 positioned between the rotating reflector 15 and the light source 5 such that the outward portion 31 of each light ray passes through the beam splitter 30 to continue along the respective outward path 25. The outward portion 31 then returns along the respective return path 29 whereby the return portion 32 of the outward portion 31 is redirected by the beam splitter 30 for sensing.

In another variation, each light ray of the subset of light rays 10 and 14 is redirected back along the respective return path 29 such that the respective return path is offset from the respective outward path 25. The present embodiment further includes using the sensing means 26 having the sensing surface 33 and the hole 34 passing through the sensing surface. As described above, the sensing means 26 is positioned between the rotating reflector 15 and the light source 5 such that each light ray passes through the hole 34 on the respective outward path 25 and strikes the sensing surface 33 on the respective return path 29.

As above, it will be appreciated that the respective return path 29 does not have to be exactly parallel to the respective outward path 25, but can deviate slightly at a small angle to the respective outward path 25, as best shown in FIG. 13(b).

The present embodiment of the method also includes using the one or more calibration sensors 36 to determine the time sequence of the plurality of light rays, thereby allowing each light ray to be identified.

The present invention provides many significant advantages over the prior art. The light rays can be generated in any pattern since the reflecting means are configured to reflect the light rays as parallel, uniformly spaced apart light rays along each sensing plane. A particular advantage is that the light rays can be divergent light rays generated from a single light source. This significantly reduces the number of components required, particularly, relatively expensive well-collimated light sources, such as lasers.

Another important advantage is that the light rays from the light source are transformed into parallel light rays and redirected along each sensing plane adjacent only one edge of the sensing plane. This minimizes the path length of the light rays, which minimizes light loss and laser spot size growth as the light rays propagate. This, in turn, improves sensing resolution and accuracy over the prior art. Each first reflector provides the significant advantage of transforming the light rays into parallel light rays and redirecting the light rays to the respective sensing planes with just one reflector. Having a plurality of reflecting facets, the footprint of each first reflector is minimized, thereby minimizing overall system size and improving compactness.

Another advantage of the present invention is that an orthogonal, uniform grid of light rays can be generated across the sensing planes. This results in better and significantly more consistent resolution and accuracy in detecting touch inputs.

The inclusion of return reflectors also reduces the number of components, particularly the number of sensing means required. Since the light rays are reflected back towards each respective light source, the number of sensing means required corresponds to the number of light sources. In embodiments where there is only a single light source, only a single sensor is required. Furthermore, each sensor can be located closely adjacent the corresponding light source, facilitating installation and maintenance of these components since they are located together. In preferred embodiments, each light source and corresponding sensor can form a single scanning and sensing module, further facilitating installation and maintenance.

In embodiments with a touch panel, further advantages include better protection for the components, such as the light source and the sensor, since these components are located underneath the touch panel, and therefore isolated from users and the external environment. In embodiments where one or more of the second reflectors is a reflective edge of the touch panel, this advantage is further enhanced since each second reflector is also isolated from users and the external environment. This also ameliorates the problem of erroneous detections caused by foreign materials such as dust or dirt falling onto the touch panel and obstructing the light rays in embodiments where the light rays are reflected above and across the touch panel.

Although the invention has been described with reference to specific examples, it will be appreciated by those skilled in the art that the invention can be embodied in many other forms. It will also be appreciated by those skilled in the art that the features of the various examples described can be combined in other combinations.

1. A sensing system for sensing a touch input on a touch sensitive device, the system including:
a sensing plane;
a well-collimated light source for generating a plurality of light rays along one or more planes different from the sensing plane; and
a reflecting means adjacent one edge of the sensing plane for transforming at least a subset of the light rays into substantially parallel light rays and redirecting the subset of light rays along the sensing plane, at least one of the light rays along the sensing plane being interruptable by the touch input thereby allowing the sensing system to determine a position coordinate of the touch input.

2. A sensing system according to claim 1 including:
a second said sensing plane that is also different to the one or more planes along which the plurality of light rays are generated; and
a second said reflecting means adjacent one edge of the second sensing plane for transforming a second subset of the light rays into substantially parallel light rays and redirecting the second subset of light rays along the second sensing plane in a direction different to the direction of the first subset of light rays, the first and second subsets of light rays thereby forming a light grid, and at least one of the light rays from the second subset along the second sensing plane being interruptable by the touch input thereby allowing the sensing system to determine a second position coordinate of the touch input.

3. A sensing system according to claim 2 wherein the first and second subsets of light rays are substantially orthogonal to each other, the light grid thereby being a substantially orthogonal light grid.

4. A sensing system according to claim 1 wherein the reflecting means includes a first reflector and a second reflector, the first reflector redirecting the subset of light rays from the light source to the sensing plane, and the second reflector redirecting the subset of light rays from the first reflector such that the subset of light rays runs along the sensing plane.

5. A sensing system according to claim 4 wherein one of the first and second reflectors transforms the subset of light rays into substantially parallel light rays.

6. A sensing system according to claim 5 wherein the first reflector transforms the subset of light rays into substantially parallel light rays and the second reflector is a planar reflector to redirect the parallel light rays along the sensing plane.

7. A sensing system according to claim 6 wherein the first reflector includes a plurality of reflecting facets each tilted with respect to a plane orthogonal to a respective light ray of the subset of light rays to redirect the respective light ray to the sensing plane in a direction substantially parallel to the other light rays of the subset.

8. A sensing system according to claim 1 wherein the touch sensitive device includes a touch panel, and wherein the subset of light rays is on a first side of the touch panel before reaching the reflecting means.

9. A sensing system according to claim 8 wherein the sensing plane is on a second side of the touch panel, the second side opposite the first side, such that at least one of the light rays along the sensing plane is interruptable by the touch input being placed on or adjacent the touch panel thereby allowing the sensing system to determine a position coordinate of the touch input on the touch panel.

10. A sensing system according to claim 8 wherein the sensing plane passes through the touch panel such that at least one of the light rays along the sensing plane is interruptable by the touch input being placed on or adjacent the touch panel thereby allowing the sensing system to determine a position coordinate of the touch input on the touch panel.

11. A sensing system according to claim 10 wherein the touch panel includes a reflective edge that forms at least part of the reflecting means, the reflective edge redirecting the subset of light rays along the sensing plane through the touch panel.

12. A sensing system according to claim 1 including a rotating reflector, and wherein the well-collimated light source generates at least one light ray that strikes the rotating reflector thereby generating the plurality of light rays in the form of divergent light rays.

13. A sensing system according to claim 12 wherein the rotating reflector includes a rotating polygonal mirror.

14. A sensing system according to claim 12 wherein the rotating reflector includes a MEMS scanning mirror.

15. A sensing system according to claim 12 wherein each light ray of the subset of light rays traces a respective outward path from the light source to the reflecting means and along the sensing plane, the sensing system further including a sensing means and a return reflector, the return reflector being adjacent a second edge of the sensing plane, the second edge opposite the first edge, for redirecting each light ray of the subset of light rays back along a respective return path that is substantially parallel to the respective outward path to the sensing means.

16. A sensing system according to claim 15 including a beam splitter positioned between the rotating reflector and the light source such that an outward portion of each light ray passes through the beam splitter to continue along the respective outward path, the outward portion then returning along the respective return path whereby a return portion of the outward portion is redirected by the beam splitter to the sensing means.

17. A sensing system according to claim 15 wherein the return reflector is a retro reflector such that the respective return path is offset from the respective outward path, and wherein the sensing means includes a sensing surface and a hole passing through the sensing surface, the sensing means being positioned between the rotating reflector and the light source such that each light ray passes through the hole on the respective outward path and strikes the sensing surface on the respective return path.

18. A sensing system according to claim 15 wherein the sensing means includes an optical sensor.

19. A sensing system according to claim 18 wherein the optical sensor includes a semiconductor photodiode.

20. A sensing system according to claim 12 including one or more calibration sensors each positioned at a respective predetermined location, a respective one of the plurality of light rays striking a corresponding one of the calibration sensors whereby the time sequence of the plurality of light rays can be determined, thereby allowing each light ray to be identified.

21. A sensing system according to claim 1 wherein the well-collimated light source generates infrared light.

22. A sensing system according to claim 1 wherein the well-collimated light source includes a laser or an LED.

23. A method of sensing a touch input on a touch sensitive device, the method including:
generating a plurality of well-collimated light rays along one or more planes different from a sensing plane; and
adjacent one edge of the sensing plane, transforming at least a subset of the light rays into substantially parallel light rays and redirecting the subset of light rays along the sensing plane, at least one of the light rays along the sensing plane being interruptable by the touch input thereby allowing a position coordinate of the touch input to be determined.

24. A method according to claim 23 wherein the one or more planes along which the plurality of light rays is generated are also different to a second said sensing plane, and the method includes:
adjacent one edge of the second sensing plane, transforming a second subset of the light rays into substantially parallel light rays and redirecting the second subset of light rays along the second sensing plane in a direction different to the direction of the first subset of light rays, the first and second subsets of light rays thereby forming a light grid, and at least one of the light rays from the second subset along the second sensing plane being interruptable by the touch input thereby allowing a second position coordinate of the touch input to be determined.

25. A method according to claim 24 wherein the first and second subsets of light rays are substantially orthogonal to each other, the light grid thereby being a substantially orthogonal light grid.

26. A method according to claim 23 including a first step of redirecting the subset of light rays to the sensing plane, and then a second step of redirecting the subset of light rays along the sensing plane.

27. A method according to claim 26 wherein one of the first and second steps includes transforming the subset of light rays into substantially parallel light rays.

28. A method according to claim 27 wherein the first step includes transforming the subset of light rays into substantially parallel light rays.

29. A method according to claim 28 including using a respective reflecting facet of a reflector to redirect each light ray of the subset of light rays to the sensing plane in a direction substantially parallel to the other light rays of the subset, each reflecting facet tilted with respect to a plane orthogonal to the corresponding light ray.

30. A method according to claim 23 wherein the touch sensitive device includes a touch panel, and wherein the subset of light rays is on a first side of the touch panel before being redirected to the sensing plane.

31. A method according to claim 30 wherein the sensing plane is on a second side of the touch panel, the second side opposite the first side, such that at least one of the light rays along the sensing plane is interruptable by the touch input being placed on or adjacent the touch panel thereby allowing a position coordinate of the touch input on the touch panel to be determined.

32. A method according to claim 30 wherein the sensing plane passes through the touch panel such that at least one of the light rays along the sensing plane is interruptable by the touch input being placed on or adjacent the touch panel thereby allowing a position coordinate of the touch input on the touch panel to be determined.

33. A method according to claim 32 wherein the touch panel includes a reflective edge, and the method includes using the reflective edge of the touch panel to redirect the subset of light rays along the sensing plane through the touch panel.

34. A method according to claim 23 wherein the plurality of light rays is generated in the form of divergent light rays by firing at least one light ray from a well-collimated light source at a rotating reflector.

35. A method according to claim 34 wherein the rotating reflector includes a rotating polygonal mirror.

36. A method according to claim 34 wherein the rotating reflector includes a MEMS scanning mirror.

37. A method according to claim 34 wherein each light ray of the subset of light rays traces a respective outward path from the light source to the sensing plane and along the sensing plane, the method further including:
adjacent a second edge of the sensing plane opposite the first edge, redirecting each light ray of the subset of light rays back to the light source along a respective return path that is substantially parallel to the respective outward path; and
sensing each light ray of the subset of light rays on the respective return path.

38. A method according to claim 37 including using a beam splitter positioned between the rotating reflector and the light source such that an outward portion of each light ray passes through the beam splitter to continue along the respective outward path, the outward portion then returning along the respective return path whereby a return portion of the outward portion is redirected by the beam splitter for sensing.

39. A method according to claim 37 wherein each light ray is redirected back along the respective return path such that the respective return path is offset from the respective outward path, and the method includes using a sensing means having a sensing surface and a hole passing through the sensing surface, the sensing means being positioned between the rotating reflector and the light source such that each light ray passes through the hole on the respective outward path and strikes the sensing surface on the respective return path.

40. A method according to claim 37 including using an optical sensor to sense each light ray on the respective return path.

41. A method according to claim 40 wherein the optical sensor includes a semiconductor photodiode.

42. A method according to claim 34 including using one or more calibration sensors to determine the time sequence of the plurality of light rays, thereby allowing each light ray to be identified, each calibration sensor being positioned at a respective predetermined location, a respective one of the plurality of light rays striking a corresponding one of the calibration sensors.

43. A method according to claim 23 wherein the plurality of light rays are infrared light rays.

44. A method according to claim 23 wherein the plurality of light rays is generated by a laser or an LED.
